(19) United States
(12) Patent Application Publication
(10) Pub. No.: US 2025/0312941 A1
(43) Pub. Date: Oct. 9, 2025

(54) METHOD FOR PRODUCING OSB PANELS AND OSB PANEL PRODUCTION DEVICE

(71) Applicant: SWISS KRONO Tec AG, Luzern (CH)

(72) Inventors: Torsten Kopp, Ruhner Berge (DE); Norbert Kalwa, Horn-Bad Meinberg (DE)

(21) Appl. No.: 18/866,421

(22) PCT Filed: May 24, 2023
(86) PCT No.: PCT/EP2023/063944

§ 371 Date: Nov. 15, 2024

(30) Foreign Application Priority Data
May 31, 2022 (EP) 22176340.2

(51) Int. Cl. B27N 9/00; B27N 3/02; B27N 3/18; B27N 3/24

(52) U.S. Cl. CPC B27N 9/00; B27N 3/02; B27N 3/18; B27N 3/24

(57) ABSTRACT

The disclosure relates to a method for producing OSB panels which includes: producing coarse chips, applying a flame-retardant solution to the coarse chips, subsequently removing flame-retardant solution from the coarse chips, in particular by applying a pressure difference, resulting in coarse chips containing flame retardant, then applying glue to the coarse chips containing flame retardant, thus obtaining glued coarse chips, and pressing the coarse chips, thus obtaining the OSB panel.

### FIELD OF INVENTION

The invention relates to a method for producing OSB panels (oriented strand board), which can also be referred to as coarse chipboards. According to a second aspect, the invention relates to an OSB panel production device with (a) a coarse chip production device for producing coarse chips from wood, (b) a dryer for drying the coarse chips, which is connected to the coarse chip production device, (c) a spreading device for spreading the coarse chips, resulting in a coarse chip layer, and (d) a belt conveyor arranged downstream of the dryer in the direction of material flow for conveying the coarse chip layer. The OSB panel production device can also be referred to a chipboard production device.

### BACKGROUND

Since flame retardant represents a considerable expense, it is beneficial to have to use as little as possible during the manufacture of flame-retardant OSB panels. One reason for this is that flame retardant itself is expensive. In addition, flame retardant means that more adhesive has to be used to obtain the same mechanical strength as a non-flame-retardant OSB panel, which is likewise undesirable. In addition, most flame retardants do not dissolve easily in water such that introducing flame retardant into the chips also means introducing large quantities of water, which have to be removed during further processing.

US 2003/0059638 A1 discloses a method for producing OSB panels in which a flame retardant is first applied to the chips by way of spraying or immersion. A vacuum or overpressure is subsequently applied in a vacuum chamber or pressure chamber in order to insert the flame retardant into the coarse chips. In a further step, the cellulose material is treated with gaseous carbon dioxide. The moist cellulose material treated in this manner is coated with a comminuted protein, such as soya flour, and pressed to form a cellulose product, such as plywood and chipboard.

WO 03/099533 A1 describes a method in which macro-chips are first produced, which are impregnated with a flame retardant by means of alternating pressure impregnation or a vacuum pressure process. The macro-chips produced in this way are then machined to create coarse chips, which are then processed to produce OSB panels.

EP 2 241 426 A1 relates to a method for producing a wood-based material panel in which a fiber cake made of wood fibers or wood chips is first produced and compressed by means of a pre-press. A vacuum is applied to one side of said fiber cake and an impregnation medium applied from the other side, which the vacuum causes to spread in the fiber cake.

U.S. Pat. No. 6,146,766 describes a vacuum pressure process in which a sodium silicate/borate mixture is used. Said mixture is subsequently polymerized through the application of heat.

### SUMMARY

The invention is based on the task of improving the production of flame-retardant OSB panels.

The invention solves the problem by way of a method for producing OSB panels, comprising the steps (a) producing coarse chips, (b) applying a flame-retardant solution to the coarse chips, (c) applying a pressure difference to the coarse chips to introduce flame-retardant solution into the coarse chips, resulting in coarse chips containing flame retardant, (d) glueing the coarse chips containing flame retardant, resulting in glued coarse chips, and (e) pressing the glued coarse chips, resulting in the OSB panel.

The invention solves the problem by way of a method for producing OSB panels, comprising the steps (a) producing coarse chips, (b) applying a flame-retardant solution to the coarse chips, (c) subsequently removing flame-retardant solution from the coarse chips, in particular by applying a pressure difference to the coarse chips, resulting in coarse chips containing flame retardant, (d) glueing the coarse chips containing flame retardant, resulting in glued coarse chips, and (e) pressing the glued coarse chips, resulting in the OSB panel.

According to a second aspect, the invention solves the problem by way of an OSB panel production device according to the preamble that comprises a flame-retardant solution application device, which is arranged to apply a flame-retardant solution to the coarse chip layer, and a pressure difference generator for applying a pressure difference to the coarse chip layer.

The advantage of the invention is that the consumption of flame retardant can usually be reduced when compared to conventionally produced OSB panels. Since a pressure difference is applied to the coarse chips, the flame-retardant solution is at least partially sucked into the coarse chips or excess flame-retardant solution is removed. As a result, less of a crust of flame retardant forms on the coarse chips.

Such a crust would be easily rubbed off during further processing, especially during mechanical transportation and scattering, and would lead to a loss of flame retardant.

A further advantage is that, by applying the differential pressure, flame retardant solution can be sucked and/or pressed into the coarse chips. According to a preferred embodiment, it is then possible to remove flame-retardant solution present on the coarse chips, for example by suction or centrifuging. This means that less water is introduced into the coarse chips than in known methods. As a result, less water has to be removed during further processing of the coarse chips than in known OSB panel production methods.

However, it is also possible that the flame-retardant solution penetrates into the coarse chips without this being supported by an overpressure or a negative pressure. Flame-retardant solution is then removed from the coarse chips, for example by applying a pressure difference.

The feature that any flame-retardant solution on the coarse chips is removed is understood particularly to mean that flame retardant that has penetrated into the coarse chips is not removed. It has been found that the increase in fire resistance is primarily due to the fact that flame retardant penetrates into the coarse chips, whereas flame retardant that remains on the surface of the coarse chips mainly leads to increased consumption of glue. Applying the flame-retardant solution to the dried coarse chips ensures that the flame retardant penetrates into the interior of the coarse chips. The vacuum is not needed for this. The subsequent removal of the flame-retardant solution on the coarse chips prevents an excessive consumption of glue.

The pressure difference is preferably, but not necessarily, applied separately in terms of time and/or location to the application of the flame-retardant solution. Preferably, the time interval is at least 1 second, especially at least 5 seconds. The interval is usually a maximum of one week.

The feature of removing the flame-retardant solution from the coarse chips is understood in particular to mean that flame-retardant solution found on the surface of the coarse chips is at least partially removed. Preferably, any flame-retardant solution that has already penetrated into the coarse chips is not removed, or is only removed to a small extent, for example at most 10 percent by weight.

In addition, it is often beneficial that fewer chemical reactions occur with the adhesive due to optional sucking and/or pressing the flame-retardant solution into the coarse chips. Therefore, the amount of adhesive has to generally be increased significantly less in order to make up for a loss of moisture caused by adding the flame retardant.

If, as intended according to a preferred embodiment of the invention, flame-retardant solution, which is removed, blown and/or sucked off and/or spun off of the coarse chips when the differential pressure is applied, is reapplied to the coarse chips, the amount of flame-retardant solution that is not introduced into an OSB panel is also reduced. Preferably, removal occurs after the application of the flame-retardant solution, not simultaneously. This is understood particularly to mean that the pressure difference is only applied to at least a majority of the coarse chips, in particular at least 80 percent by weight, particularly preferably at least 90 percent by weight, once the flame-retardant solution has been applied. Particularly preferably, the point at which the flame-retardant solution is applied to the coarse chips is spaced apart from the point at which the pressure difference is applied. The distance is preferably at least 10 cm, in particular at least 1 m. The distance is preferably at most 100 m.

It is beneficial if the flame-retardant solution that is removed, especially blown and/or sucked off of the coarse chips when the differential pressure is applied is purified prior to reapplication, for example by filtering and/or centrifugation. In this way, any wood components are separated from the flame-retardant solution, for example.

Within the context of the present description, the coarse chips are to be understood as wood chips that lie in the size range 200±30 cm×20±4 cm×0.5±0.2 cm.

In particular, the method according to the invention is a method for producing flame-retardant OSB panels that comply with DIN EN 13823 (single burner item) and/or are flame-retardant in accordance with DIN EN 13501-1.

The flame-retardant solution is preferably an aqueous solution. The flame-retardant solution preferably contains at least one organic or inorganic compound that contains phosphorus and/or nitrogen. According to one embodiment, the flame retardant is an inorganic salt.

The application of the flame-retardant solution to the coarse chips is understood in particular to mean spraying or spraying them on.

According to a first embodiment, the application of the pressure difference to the coarse chips is understood to mean that a pressure difference is generated between a first lateral surface of the coarse chips and the opposite lateral surface of the coarse chips. The two lateral surfaces are spaced apart from each other by the height of the coarse chip, which is 0.5±0.2 centimeters.

According to a second embodiment, the application of the differential pressure to the coarse chips is understood to mean that a pressure is applied to the coarse chips, particularly the coarse chip layer, said pressure differing from the ambient pressure, especially by at least 200 hPa, preferably at least 400 hPa, especially preferably at least 600 hPa. The pressure may be an overpressure or a negative pressure.

The feature that the coarse chips are pressed to obtain the OSB panel is understood particularly to mean that at least the coarse chips are pressed. In particular, it is also possible that further chips, which are not coarse chips, are pressed with the coarse chips. In addition, it is possible and represents a preferred embodiment that a first surface layer and a second surface layer made of the coarse chips are scattered and pressed with a middle layer, which is arranged between the two surface layers, to form an OSB layer.

The feature that the flame-retardant solution is applied to the coarse chips is understood particularly to mean that the coarse chips are not in a pressed form when the flame-retardant solution is applied. In other words, the flame-retardant solution is applied to unpressed coarse chips.

The glueing preferably occurs without the pressure difference acting on the coarse chips.

According to one preferred embodiment, the method comprises the steps (a) arranging the coarse chips on a transport belt, resulting in a coarse chip layer, and (b) applying the flame-retardant solution to the coarse chip layer. In this way, the coarse chips can be quickly, homogeneously and reliably wetted with flame-retardant solution.

Preferably, the application of the pressure difference to the coarse chips wetted with the flame-retardant solution constitutes an application of a negative pressure to a lower side of the transport belt. For this purpose, the transport belt is permeable to gas. For example, the transport belt is perforated or made of a gas-permeable material, such as a textile. Alternatively, the transport belt may be a metal belt. This metal belt is preferably perforated.

Alternatively or in addition, the application of the pressure difference to the coarse chips wetted with the flame retardant solution constitutes an application of an overpressure to an upper side of the coarse chip layer. This is done, for example, by the coarse chip layer first passing a roller that acts as a seal and then entering an overpressure area where the overpressure is applied. The coarse chip layer lies on a gas-permeable conveyor belt with a low pressure, such as an ambient pressure or negative pressure, acting on the side facing away from the overpressure area. The coarse chip layer leaves the overpressure area by passing a roller that acts as a seal.

The method for producing the coarse chips preferably includes drying the coarse chips. In other words, the coarse chips are dried before applying the flame-retardant solution. The drying can be done on the same transport belt as the application of the flame retardant solution and, where appropriate, the application of the pressure difference; this, however, is not essential. The coarse chips are preferably dried until they are kiln-dry. In this state, flame-retardant solution can be absorbed particularly quickly and easily by the dried coarse chips.

According to a preferred embodiment, the coarse chips containing the flame retardant are not substantially dried. This is to be understood to mean that the moisture content of the coarse chips containing the flame-retardant solution changes by at most five percentage points, in particular at most two percentage points, before and/or after glueing and before pressing.

Alternatively, the coarse chips containing the flame-retardant solution are dried. This is achieved, for example, using a belt dryer. Preferably, the coarse chips containing the flame-retardant solution are dried at a temperature of at least 50°, especially at least 55°, and/or at most 100°, especially at most 90°, especially preferably at most 85°. The coarse chips containing flame-retardant solution are particularly dried until a residual moisture is at most 9 percent by weight, especially at most 8 percent by weight, especially preferably at most 10 percent by weight, especially at most 9 percent by weight, especially preferably at most 8 percent by weight.

Preferably, the coarse chip layer has a chipboard layer thickness that corresponds at most to four times, preferably at most three times, preferably at most twice, a coarse chipboard layer thickness of a single coarse chipboard layer. The coarse chipboard layer thickness is the minimum possible thickness of a coarse chipboard layer. This is the average height of an arrangement of coarse chips on a flat, horizontal test surface of 1 m2, wherein for said arrangement sections of two or more coarse chips lie on top of each other on at most 75% of the test surface and wherein at least 90%, preferably at least 95%, in particular 100%, of the test surface is covered by coarse chips.

When applied to the coarse chip layer, the flame-retardant solution preferably has a temperature of at least 50° C., preferably at least 60°° C., in particular at least 70° C. A high temperature generally increases the solubility of the flame retardant in the solvent so that less solvent, usually water, is required to dissolve a given quantity of flame retardant. In addition, the viscosity of water decreases at the temperature increases, so that the flame-retardant solution can penetrate more easily into the coarse chips.

It is beneficial if the flame-retardant solution has a concentration of flame retardant that corresponds to at least 60%, in particular at least 70%, preferably at least 80%, especially preferably at least 90%, of the maximum solubility of the flame retardant.

It is practical for the flame-retardant solution to contain a concentration of flame retardant that is 30 percent by weight, in particular at least 40 percent by weight, preferably at least 45 percent by weight.

According to one embodiment, at least 18 percent by weight, especially at least 20 percent by weight, preferably at least 22 percent by weight, of flame retardant is applied to the coarse chips. In other words, at least 18 g of flame retardant is applied to 100 g coarse chips. Preferably, at most 30 percent by weight, especially at most 28 percent by weight, preferably at most 26 percent by weight, of flame retardant is applied to the coarse chips. These figures refer to the flame retardant in the flame-retardant solution and are independent from the quantity of solvent.

The flame-retardant solution preferably contains a viscosity reducer. Alternatively or additionally, the flame-retardant solution preferably contains a surfactant. This improves the wetting of the coarse chips.

It is beneficial if the method comprises the following steps: (a) producing coarse and middle layer chips, (b) joint drying of the coarse chips and the middle layer chips, (c) separating coarse chips and middle layer chips, (d) applying the flame-retardant solution, in particular to the coarse chips, preferably only to the coarse chips, (e) producing a first surface layer and a second surface layer from the coarse chips containing the flame retardant and a middle layer at least also from the middle layer chips and (f) pressing the first surface layer, the second surface layer and the middle layer to form the OSB panel. This results in an OSB panel which is flame-retardant on the one hand and on the other does not contain more flame retardant than necessary.

The flame-retardant solution preferably contains a coloring agent. Said coloring agent is preferably colorless in the visible range. In this case, the coloring agent can also be referred to as a marker. It is beneficial if the coloring agent absorbs and/or fluoresces in the UV range. In this case, a flame retardant distribution of the flame-retardant solution and/or the flame retardant can be detected by irradiation with UV light and/or recording an image of the coarse chip layer and/or the OSB board with a camera sensitive in the UV range. According to a preferred embodiment, the flame retardant distribution can then be used to control a process parameter in the form of the conveyor belt speed of the conveyor belt and/or the pressure difference and/or an area-specific application rate of flame-retardant solution. In other words, a deviation between a target flame retardant distribution and the actual flame retardant distribution measured is determined and at least one of the named parameters controlled in such a way that the deviation is minimized.

An OSB panel production device according to the invention preferably comprises an inspection system for detecting the flame retardant distribution of flame retardant in the coarse chip layer. This may refer to the distribution of the flame retardant in the surface of the coarse chip layer, i.e. the two-dimensional distribution in the longitudinal direction and the direction of width of the coarse chip layer, but not in the direction of thickness.

Alternatively or additionally, the inspection system can be designed to detect the flame retardant distribution in the OSB panel. This may then refer to the distribution of the flame retardant in the surface of the OSB panel, i.e. the two-dimensional distribution in the longitudinal direction and the direction of width of the coarse chip layer and/or the distribution of the flame retardant in the direction of thickness.

The inspection system preferably has a camera for detecting UV light and/or fluorescent light that occurs when irradiating the coarse chip layer or the OSB panel with UV light. Preferably, the inspection system also has a UV light source for irradiating the coarse chip layer or the OSB panel with UV light.

The coarse chip production device preferably comprises a chipper, by means of which the coarse chips are produced from wood.

The pressure difference generator preferably comprises a negative pressure pump and at least one suction chamber, preferably at least two suction chambers, especially a plurality of suction chambers, each of which is connected to the negative pressure pump via a valve. The valves are preferably designed to enlarge the degree of valve opening as pressure in the suction chamber decreases. In other words, the valves open further the lower the pressure in the respective suction chamber.

The suction chambers are preferably arranged in such a way that at least 90% of the surface, preferably at least 95% of the surface, especially preferably 100% of the surface of the coarse chipboard layer can be subjected to the pressure difference, in the present case a negative pressure, for at least a predetermined time of 1 second, for example, especially at least 5 seconds, by means of at least one suction chamber in each case.

A negative pressure is preferably at least 300 hPa (which corresponds to an absolute pressure of 713 hPa), in particular at least 500 hPa (which corresponds to an absolute pressure of 513 hPa under standard conditions).

Preferably, the segments are designed to apply different negative pressures. In particular, the pressures differ in at least two segments by at least 30 hPa. The greater the negative pressure, the more efficiently the flame retardant that is not absorbed by the coarse chips is sucked away. However, the greater the negative pressure, the more power is required. It may therefore be beneficial to first suck a majority of excess flame retardant off with a lower negative pressure and then to suck the remaining flame retardant off with a larger negative pressure.

Preferably, an OSB panel production device according to the invention preferably comprises a spreading device, which could also be referred to as a homogeniser and by means of which a homogeneous distribution of the coarse chips across the transport clamping width is set. For example, the spreading device has a combing device.

The OSB panel production device preferably has an application booth where the flame retardant is applied to the coarse chips. It is beneficial if a lock is arranged upstream of the application booth in the direction of material flow.

The OSB panel production device preferably has a glueing unit for glueing the coarse chips. The glueing unit, which can also be referred to as a glueing device, is preferably designed to glue the coarse chips with PDMI (polymeric diphenylmethane diisocyanate). For this purpose, the glueing unit has, for example, a glue tank that contains PDMI. For example, the coarse chips containing flame retardant are glued with 4±0.5, especially 4±0.25 percent by weight of PDMI.

The OSB panel produced preferably corresponds to building material class B in accordance with SBI test DIN EN 13823.

### DETAILED DESCRIPTION OF DRAWINGS

In the following, the invention will be explained in more detail with the aid of the accompanying drawings. They show:

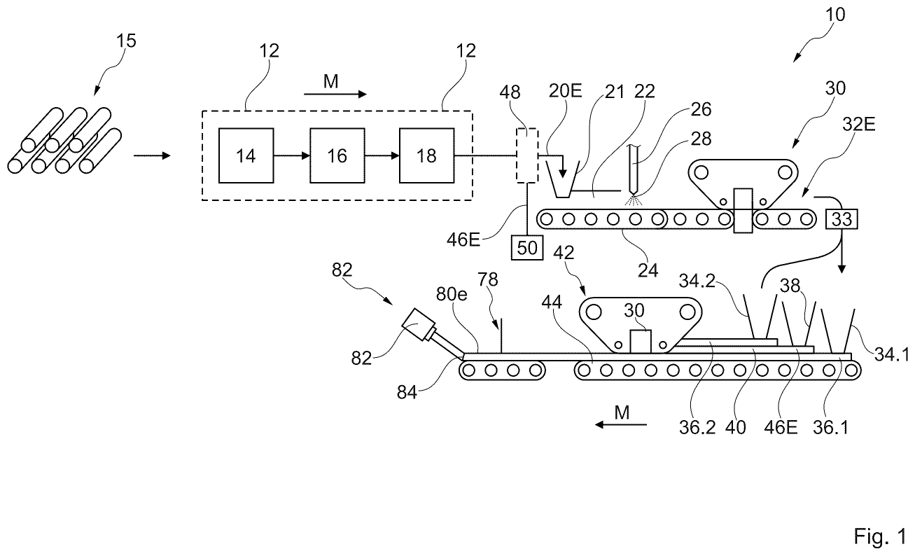

FIG. 1 shows a schematic view of an OSB panel production device according to the invention for carrying out a method according to the invention and

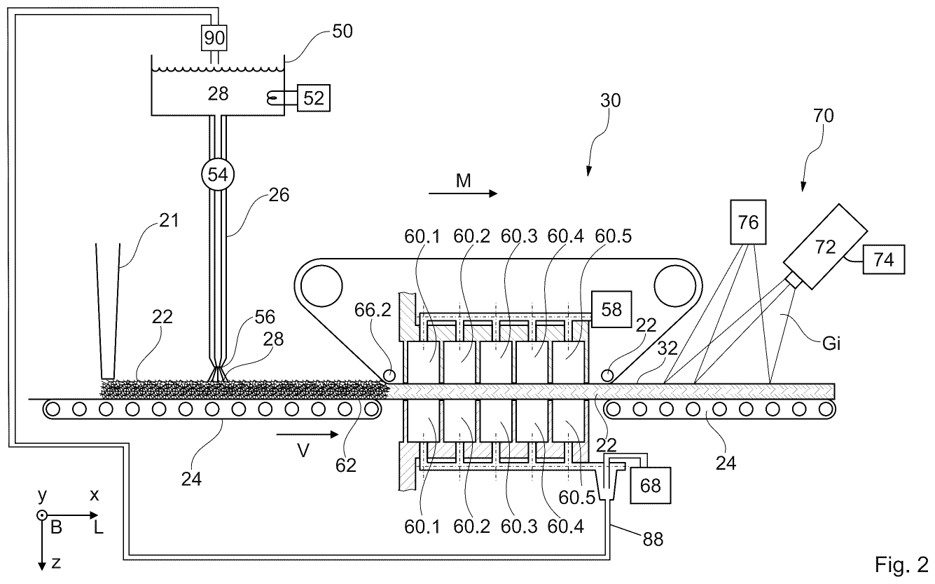

FIG. 2 shows a schematic detailed view of the OSB panel production device according to FIG. 1.

### DETAILED DESCRIPTION

FIG. 1 schematically depicts an OSB panel production device 10 according to the invention that comprises a coarse chip production device 12. The coarse chip production device 12 comprises a debarking unit 14 for debarking wood 16, a coarse chipper 16 arranged downstream of the debarking unit 14 in the direction of material flow M and a dryer 18 arranged downstream of said chipper in the direction of material flow M. The coarse chip production device 12 thus produces coarse chips 20.i (i=1, 2, 3, . . . ).

The coarse chips 20.i produced in this manner are scattered onto a belt conveyor 24 by a schematically depicted distribution device 21 to form a coarse chip layer 22 and wetted with a flame-retardant solution 28 by means of a flame-retardant solution application device 26. A pressure difference is subsequently applied to the coarse chip layer 22 by means of a pressure difference generator 30 so that the flame-retardant solution 28 penetrates into the coarse chips 20.i. This results in coarse chips containing flame retardant 32.i, which have less flame retardant on their surface.

Glue is applied to the coarse chips containing the flame retardant 32.i by means of a glueing device 33. The glueing device 33 may be, for example, a mixer or a coil, i.e.

a rotating drum.

The glued coarse chips 31.i are scattered by a first scattering head 34.1 to form a first surface layer 36.1. A middle layer 40 is scattered onto the first surface layer 20.1 by means of a middle layer scatterer 38. A second scattering head 34.2 is used to scatter a second surface layer 36.2 onto the middle layer 40. The layers 36.1, 40, 36.2 are pressed by means of a hot press 42 to form an OSB panel 44.

The middle layer scatterer 38 scatters middle layer chips 46.i, which are either produced by means of a middle chip production device or separated from the coarse chips 20.i via screening by means of, in this case, a classifier 48. The middle layer chips 46.i are subsequently glued in a second glueing unit 50 and then transported to the middle layer scatterer 38.

By means of a return device, for example a return line 88, flame-retardant solution 28, which is removed from the coarse chips 20 when the pressure difference is applied to the coarse chips 20, is returned to the reservoir 50. The return line 88 may comprise a filter 90, by means of which wood particles are removed. In addition, the return line preferably comprises a pump for pumping the flame-retardant solution. FIG. 2 shows the distribution device 21, the flame-retardant solution application device 26 and the pressure difference generator 30. The flame-retardant solution application device 26 comprises a reservoir 50 that holds the flame-retardant solution 28. The flame-retardant solution 28 can be brought up to a given temperature T₂₈ by means of a heater 52, wherein for example 50° C.≤T₂₈≤95° C. The flame-retardant solution 28 is guided to nozzles 56.k by means of a dosing pump 54, said nozzles being arranged next to each other transversely to the direction of material flow M, and from there are sprayed onto the coarse chip layer 22.

The pressure difference generator 30 has a negative pressure pump 58, which is connected to a plurality of suction chambers 60.j (j=1, 2, . . . ). As a result, a pressure pⱼ of 100 hPa≤p_{j≤}800 hPa, for example, acts on the suction chambers 60.j during operation of the negative pressure pump 58. In this case it is possible that the pressures in the individual suction chambers 60.j differ from one another.

The suction chambers 60.j rest on a transport belt 62 of the belt conveyor 24, which has openings, for example holes. The pressure pj is thus applied to the coarse chip layer 22.

It is possible, but not essential, that the differential pressure generator 30 comprises a perforated metal belt 64, as shown in FIG. 2, which presses onto the coarse chip layer 22 from above. Pressure rollers 66.1, 66.2, for example, are provided for this purpose. The suction chambers 60.j rest on the metal belt 64 on the side of the metal belt 64 that faces away from the coarse chip layer 22. As a result, there is an introduction pressure p₂₂ of, for example, 100 hPa≤p₂₂≤800 hPa in the coarse chip layer 22 in the area of the pressure chambers 60.j.

It is also possible, but not essential, for the differential pressure generator 30 to comprise two sets of suction chamber 60.j and 60′.j, as shown in FIG. 2, between which the coarse chip layer 22 is arranged. It is possible, but not essential, that the second set of suction chambers 60′.j is connected to a second pump 68. The second pump 68 may be a vacuum pump or a pressure pump.

It is possible that the pressure pj in the first set of suction chambers 60.j is an overpressure and the pressure p′ⱼ in the second set of suction chambers 60′.j an overpressure.

Alternatively, it is possible that the pressure pⱼ is an overpressure and the pressure p′j a negative pressure.

As a further alternative, it is possible that the pressure pⱼ is a negative pressure and the pressure p′ⱼ a negative pressure.

As a further alternative, it is possible that the pressure pⱼ is a negative pressure and the pressure p′ⱼ an overpressure.

An inspection system 70 can be arranged downstream of the pressure difference generator 30 in the direction of material flow M, said system comprising a camera 72. The camera 72 detects light that is emitted or not absorbed by a coloring agent in the flame-retardant solution. Alternatively or additionally, the camera 72 detects fluorescent light. In this way, an actual flame retardant distribution kᵢₛₜ (x,y) is determined, which denotes a concentration k of flame retardant as a function of the surface coordinates x, y. A controller 74 compares the actual flame retardant distribution Kᵢₛₜ(x,y) with a target flame retardant distribution kₛₒₗₗ(x,y) and controls the nozzles 56.k individually so that a deviation between the actual flame retardant distribution kᵢₛₜ(x,y) and the target flame retardant distribution kₛₒₗₗ(x,y) is minimized.

It is possible, but not essential, that the inspection system has a UV light source, which illuminates the coarse chip layer 22 in a field of vision G of the camera 72. Thex field of vision G is the area of the coarse chip layer 22 that is captured using the camera 72. In FIG. 1, the inspection system 70 is not depicted for the sake of clarity.

FIG. 1 shows that a cutting device 78 can be arranged downstream of the hot press 42 in the direction of material flow, wherein said device cuts the OSB panel 44 into individual panel segments 80.1. In this case, it is advantageous if a second inspection system 82 is arranged, the camera of which 84 captures a cutting surface 86 of the respective panel segment 80.1. This is used to determine a second actual flame retardant distribution K_{ist,2} (y,z), which also encodes the depth dependence of the concentration k of flame retardant. In other words, the second actual flame retardant distribution k_{ist,2}(y,z) encodes a depth gradient of the coloring agent.

The controller 74 is configured to alter the pressures pj in the at least one suction chamber 60.j and/or of a transport belt speed v₆₂ of the transport belt 62 so that the second actual flame retardant distribution k_{ist,2}(y,z) approximates a second target flame retardant distribution k_{soll,2}(y,z).

1. A method for producing OSB panels comprising:
(a) producing coarse chips,
(b) applying a flame-retardant solution to the coarse chips,
(c) subsequently removing the flame-retardant solution from the coarse chips, by applying a pressure difference, resulting in coarse chips containing flame retardant,
(d) applying glue to the coarse chips containing the flame retardant, thereby obtaining glued coarse chips, and
(e) pressing the coarse chips, thereby obtaining the OSB panel.

2. The method according to claim 1, further comprising:
(a) arranging the coarse chips on a transport belt, resulting in a coarse chip layer,
(b) applying a the flame-retardant solution to the coarse chips on the transport belt, and
(c) applying a pressure difference to the coarse chips webbed by the flame-retardant solution by applying a negative pressure to a lower side of the transport belt and/or an overpressure to an upper side of the coarse chip layer.

3. The method according to claim 1, wherein the production of the coarse chips includes drying the coarse chips, wherein the drying is performed prior to applying the flame-retardant solution.

4. The method according to claim 1, wherein a chipboard layer thickness of a coarse chip layer corresponds at most to four times a coarse chipboard layer thickness of the coarse chipboard layer.

5. The method according to claim 1, further comprising removing any flame retardant solution present on the coarse chips.

6. The method according to claim 5, wherein the removal of any flame-retardant solution present on the coarse chips comprises:
(a) blowing off and/or sucking off by applying the pressure difference, and/or
(b) spinning it off.

7. The method according to claim 1, further comprising drying the coarse chips containing the flame retardant, following the removal of the flame-retardant solution present on the coarse chips.

8. The method according to claim 1, wherein the flame-retardant solution
(a) has a temperature of at least 50° C. when being applied to the coarse chip layer. and/or
(b) contains a viscosity reducer comprising a surfactant.

9. The method according to claim 1 further comprising:
(a) producing coarse and middle layer chips,
(b) joint drying of the coarse chips and the middle layer chips,
(c) separating the coarse chips and the middle layer chips,
(d) applying the flame-retardant solution to the coarse chips, thereby obtaining coarse chips that contain the flame retardant,
(e) producing a first surface layer and a second surface layer from the coarse chips containing the flame retardant and a middle layer at least from the middle layer chips, and
(f) pressing the first surface layer, the second surface layer and the middle layer to form the OSB panel.

10. The method according to claim 2, wherein:
(a) the flame-retardant solution contains a coloring agent, that is colorless and that absorbs or fluoresces in a UV range, and
(b) the method further comprises:
(i) depth-dependent; optical detection of a coloring agent concentration of the coarse chipboard layer and/or the OSB panel, thereby obtaining a coloring agent depth profile, and
(ii) controlling a transport belt speed, the pressure difference and/or an area-specific application amount of flame-retardant solution using the coloring agent depth profile.

11. An OSB panel production device comprising:
(a) a coarse chip production device which produces coarse chips from wood,
(b) a dryer which dries the coarse chips and that is connected to the coarse chip production device,
(c) a distribution device which distributes the course chips, thereby obtaining a coarse chip layer, and
(d) a belt conveyor, arranged downstream of the dryer in a direction of material flow, and which transports the coarse chipboard layer,
(e) a flame-retardant solution application device configured to apply a flame-retardant solution to the coarse chip layer, and
(f) a pressure difference generator which applies to the coarse chip layer at a pressure difference.

12. The OSB panel production device according to claim 11, further comprising an inspection system which detects a flame retardant distribution of the flame retardant in the coarse chip layer and/or in the OSB panel, the inspection system comprises:
(a) a UV light source, and
(b) a camera which detects reflected UV light and/or fluorescent light.

13. The OSB panel production device according to claim 12, further comprising a controller that is configured to automatically control a transport belt speed, the pressure difference and/or an area-specific application amount of the flame-retardant solution using the flame retardant distribution.

14. The OSB panel production device according to claim 11, wherein the pressure difference generator comprises:
(a) a negative pressure pump and a plurality of suction chambers, each of which is connected to the negative pressure pump via a valve, the valves having a degree of valve opening that increases as pressure in the suction chambers increases, and/or
(b) a pressure pump and a plurality of pressure chambers, each of which is connected to the pressure pump via a valve, the valves having a degree of valve opening that increases as pressure in the suction chambers decreases.

15. The OSB panel production device according to claim 12, further comprising a return device which returns the flame-retardant solution that has been removed from the coarse chips by the pressure difference generator to the flame-retardant solution application device.
